(19) United States
(12) Patent Application Publication
(10) Pub. No.: US 2026/0203979 A1
(43) Pub. Date: Jul. 16, 2026

(54) ADAPTIVE REAL-TIME ISP HARMONIZATION FOR BACKGROUND REPLACEMENT AND CONTENT EDITING

(71) Applicant: Intel Corporation, Santa Clara, CA (US)

(72) Inventors: Moran Klein, Ra’anana (IL); Rony Zatzarinni, Tel Aviv (IL); Dor Barber, Herzliya (IL); Hava Matichin, Petah Tikva (IL); Chaim Gross, Jerusalem (IL)

(73) Assignee: Intel Corporation, Santa Clara, CA (US)

(21) Appl. No.: 19/563,155

(22) Filed: Mar. 11, 2026

(51) Int. Cl. G06T 11/60; G06T 3/4046; G06T 7/11; G06T 7/194; G06T 11/10

(52) U.S. Cl. CPC G06T 11/60; G06T 3/4046; G06T 7/11; G06T 7/194; G06T 11/10; G06T 2207/20084

(57) ABSTRACT

Systems and methods are provided for harmonizing a foreground region with a background image during background replacement and content editing. A sensor image including a foreground region and a background region is received at an image signal processor (ISP), along with a background image having different visual characteristics. The sensor image and the background image are downscaled and processed by a harmonization neural network that predicts one or more ISP hardware block parameters. The predicted parameters are used to configure ISP hardware blocks such that the foreground region of a processed image is harmonized to match visual characteristics of the background image while preserving full sensor bit depth. The processed image is then blended with the background image to generate a harmonized output image. By performing harmonization within the ISP pipeline using low-resolution inference, the techniques reduce computational overhead and avoid quantization artifacts associated with post-processing approaches.

### TECHNICAL FIELD

This disclosure relates generally to background replacement, and in particular to harmonization for background replacement and content editing.

### BACKGROUND

In modern video conferencing and related imaging applications, background replacement has become a standard feature in which a foreground subject (e.g., a user) is segmented from a captured scene and composited onto a different background image or video. However, conventional background replacement often fails to produce a believable composition because the lighting characteristics of the foreground subject captured under real-world illumination (e.g., color temperature, tone, brightness, and related appearance attributes) frequently do not match those of the selected virtual background, resulting in an unnatural “cut-out” or visually disconnected effect.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an image signal processing (ISP) pipeline including ISP harmonization, in accordance with various embodiments.

FIG. 2 is a block diagram of an ISP pipeline including post-color ISP harmonization, in accordance with various embodiments.

FIG. 3 is a block diagram of a harmonization neural network architecture, in accordance with various embodiments.

FIG. 4 is a block diagram illustrating blend parameter generation, in accordance with various embodiments.

FIG. 5 is a block diagram of a harmonization parameter determination process in a video processing pipeline, in accordance with various embodiments.

FIG. 6 is a block diagram of a training data generation pipeline, in accordance with various embodiments.

FIG. 7 is a flowchart showing a method for ISP harmonization, in accordance with various embodiments.

FIG. 8 is a block diagram of an example DNN system, in accordance with various embodiments.

FIG. 9 is a block diagram of an example computing device, in accordance with various embodiments.

### DETAILED DESCRIPTION

### Overview

Background replacement technology is often used in video conferencing and content creation to replace a person's background with a different selected scene. A visual quality problem can arise when a foreground subject is composited onto a virtual background, or when new content is stitched into a scene, and the different images originated from different lighting conditions and/or underwent different image processing histories. In particular, the two elements can be incompatible in terms of color temperature, brightness, contrast, and overall tonal appearance. The result is an unnatural “cut-out” artifact that makes the composition visually unconvincing.

Conventional background harmonization approaches generally operate as post-ISP software post-processing, where the full image is rendered by the ISP and then classical filters and/or artificial intelligence (AI) models adjust the foreground's color/lighting to better match a replacement background. One technique uses a post-ISP convolutional neural network (CNN) to predict a piecewise curve mapping (sometimes cascading two such curves) conditioned on embeddings computed from thumbnail foreground/background images, and then applies the mapping to the full-resolution foreground. These approaches are disadvantageous for real-time video because they demand substantial compute/accelerator resources, power, memory transfers, and bandwidth. Additionally, previous approaches often use full-resolution processing or extra downscaling outside the ISP, while also operating on 8-bit post-ISP data that can clip shadows/highlights and introduce quantization artifacts such as banding and posterization during aggressive tone/color manipulation. The previous background harmonization methods are further limited by being detached from ISP pipeline control. Additionally, traditional non-AI ISP methods lack semantic awareness and rely mainly on histograms and/or statistics. Moreover, output-stream-only approaches tend to use per-frame execution unless separate scene-change logic is implemented.

Systems and methods are provided to address unnatural appearance of a video generated using background replacement by performing foreground harmonization directly within the camera's Image Signal Processor (ISP) hardware pipeline. An image signal processor (ISP) converts raw sensor data into high-quality image or video through a sequence of hardware blocks, each performing specific operations such as defective pixel correction, denoising, and sharpening. According to various implementations, a lightweight AI-based harmonization module is integrated into the existing ISP architecture without using hardware modifications. The harmonization module can operate in a parallel, low-resolution processing path already present in the ISP, where the raw sensor input is downscaled via pixel binning. In various examples, the live foreground image and the selected background image are downscaled to this same reduced resolution and fed into a harmonization neural network. Because the harmonization task utilizes global adjustments (e.g., adjustments applied uniformly across the foreground segment, such as adjustments affecting color temperature, brightness, and contrast), full-resolution image data is unnecessary. The low-resolution image path is sufficient for determining harmonization parameters, and the low-resolution image path is computationally efficient.

According to various implementations, a background/foreground segmentation AI model, already present in the ISP's parallel processing path, generates a pixel-level segmentation mask identifying which regions of the scene constitute the foreground subject (e.g., a person, object, or newly inserted content) and which constitute the background. The segmentation mask is passed as a third input to the harmonization neural network, alongside the downscaled foreground and background images, enabling the network to apply targeted harmonization corrections exclusively to the foreground region.

In various implementations, the harmonization neural network is a compact deep neural network, and is followed by multilayer perceptrons (MLPs) that extract embeddings separately from the foreground and background images and then predict a small set of hardware configuration parameters for the relevant ISP blocks. The harmonization neural network's output is a set of ISP block parameters. In some examples, the set of ISP block parameters includes a tone mapping correction curve and a 3×3 color mapping matrix. Because the background image is static (i.e., fixed for the duration of a session), its feature embeddings can be determined once and cached, reducing redundant computation.

According to various implementations, systems and methods are provided for various configurations of ISP blocks for harmonization. A first example configuration is color reproduction harmonization. In color reproduction harmonization, the White Balance (WB) block, the Color Correction Matrix (CCM) block, and the Tone Mapping (TM) block are manipulated together. The three blocks collectively govern how color temperature, color fidelity, and tonal response are rendered, and adjusting them in concert enables a thorough harmonization of the foreground to the background's lighting context. A second example configuration is post-color reproduction harmonization. In post-color reproduction harmonization, the Tone Mapping block and the Color Space Conversion (CSC) block are manipulated. In this approach, the standard RGB-to-YUV conversion matrix is augmented with an additional RGB-to-RGB color mapping matrix, effectively embedding a color harmonization operation directly into the CSC hardware block with no additional hardware cost.

According to various examples, performing harmonization within the ISP pipeline allows for the preservation of full sensor bit depth throughout processing. Standard ISP sensors capture data at 10-12 bits (and 12-16 bits in HDR configurations, up to 20-24 bits in some implementations). In contrast, post-processing systems that operate on the final 8-bit output are inherently susceptible to quantization artifacts, visible banding, and posterization, especially when applying the aggressive brightness stretching and color mapping performed by harmonization. By applying the harmonization corrections within the pipeline at full bit depth, the techniques provided herein avoid the degradation artifacts entirely.

According to various implementations, the systems and methods provided herein incorporate a blend parameter control mechanism that interpolates between the ISP's original hardware configuration parameters and the neural network-predicted harmonization parameters using a scalar blending factor alpha (α∈[0,1]). When a=0, no harmonization is applied; when α=1, the full neural network-predicted correction is applied. In various examples, blending can be set manually or determined automatically. In automatic mode, the ISP leverages its existing face detection and skin tone statistics aggregation capabilities to constrain a such that the resulting skin tones of harmonized faces remain within the natural range of hue, saturation, and brightness. This prevents both over-harmonization (where skin becomes unnaturally saturated or hue-shifted) and under-harmonization (where the correction is too weak to achieve a convincing result). The mechanism is also semantically aware: because the AI model understands that skin tones occupy a constrained region of color space while non-person objects may occupy a much broader range, it can apply differentiated harmonization strengths to objects of different semantic classes even when the objects share similar initial colors.

According to some implementations, techniques are provided to maintain temporal stability and reduce power consumption in video applications by decoupling the harmonization inference from the video frame rate. In particular, the system can exploit the ISP's scene-change detection capability to trigger harmonization re-determination when a meaningful change in scene conditions is detected, instead of running the harmonization neural network at every frame (e.g., 30+ fps). In various examples, the ISP continuously aggregates statistics about illumination, color temperature, and scene intensity, and can thereby detect scene change.

The neural network model can be trained using a supervised learning approach based on synthetically generated image pairs. Real photographic scenes, which are inherently harmonized because subject and background share the same lighting, serve as ground truth. Non-harmonized composite inputs are generated by identifying semantically matched object pairs from different scenes (e.g., two different people photographed under different lighting conditions) and determining a color transfer function between the matched object pairs using luminance statistics, color temperature statistics, and histogram matching. The color transfer function can be applied to the foreground region of the ground truth image to produce a plausible but scene-inconsistent input. The harmonization neural network is trained to predict the ISP parameters that map the non-harmonized input back to the ground truth, with loss computed as a pixel-wise masked L1 distance over the foreground region. In some examples, to prevent the network from enforcing corrections when none are needed, 10% of training samples use the ground truth image directly as the composite input, training the neural network model to output identity operators in those cases.

In various implementations, a harmonization module is assembled in a dedicated block that combines the harmonized foreground output from the ISP pipeline with the selected background image using the foreground segmentation mask: pixels where the mask value is 1 are drawn from the harmonized ISP output, and pixels where the mask value is 0 are drawn from the background image. The blending generates the final composited frame in which the foreground subject's color temperature, brightness, and contrast are naturally aligned with the synthetic background, achieving a coherent and visually convincing result. In various examples, the harmonization module generates a harmonized output frame without additional hardware, without post-processing software overhead, and without the quantization or artifact risks inherent in 8-bit post-ISP manipulation.

According to various implementations, the blending mask is a soft mask with values ranging from 0 to 1. For example, the blending mask can be a probabilistic map of the foreground segmentation. In some examples, a soft mask allows for a gradual and smooth transition from the harmonized foreground to the synthetic background.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as implying that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Adaptive Real-Time ISP Harmonization System

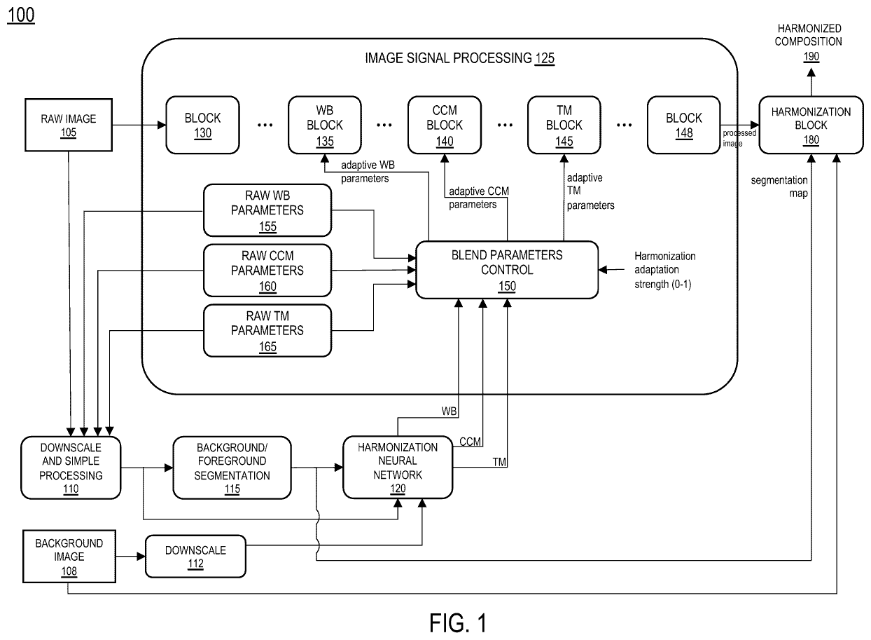

FIG. 1 is a block diagram of an adaptive real-time ISP harmonization system 100 including an image signal processing (ISP) pipeline 125, in accordance with various embodiments. The ISP pipeline 125 receives a raw image 105 from a camera sensor as input. The raw image 105 is an unprocessed sensor output capturing the scene at full bit depth, typically 10-16 bits or higher in HDR configurations. The raw image 105 is routed along two parallel processing paths within the system 100: a primary full-resolution processing path through the ISP pipeline 125, and a parallel low-resolution processing path beginning at the downscale and simple processing block 110.

The primary full-resolution processing path within the ISP pipeline 125 includes a series of hardware blocks arranged in sequence. According to various implementations, the pipeline 125 begins with block 130, which performs early-stage operations such as black level correction and demosaicing. Downstream of block 130, a white balance (WB) block 135, a color correction matrix (CCM) block 140, and a tone mapping (TM) block 145 perform the core color reproduction operations of the ISP pipeline 125. The WB block 135 adjusts the global color cast of the image so that neutral colors are rendered as neutral in the output. The CCM block 140 fine-tunes color reproduction across the full color gamut so that colors such as skin tones, sky, and foliage are rendered accurately. The TM block 145 adjusts the brightness and contrast of the image by applying tone mapping operations, which can include both global tone mapping and local tone mapping. In some examples, global tone mapping includes a tone curve being applied uniformly across the image as a function of each pixel's luma value. In some examples, the harmonization corrections applied by the blend parameters control block 150 addresses the global tone mapping component of the TM block 145. In some examples, TM block 145 adjusts the brightness and contrast of the image by applying a tone curve that maps input luminance values to output luminance values. In some examples, a further block 148 performs any remaining downstream processing operations before the processed image is passed out of the ISP pipeline 125 to the harmonization block 180.

According to various implementations, the parallel low-resolution processing path begins at the downscale and simple processing block 110, which receives the raw image 105 and produces a downscaled version of the scene. In some examples, the downscaled version of the scene is downscaled at a reduction ratio of 1/8, by applying pixel binning. In some examples, the downscaled version of the scene is downscaled at a reduction ratio of one of: 1/2, 1/4, 1/6, 1/10, 1/12, less than 1/12, or any other selected reduction ratio. The downscale and simple processing block 110 performs a simplified version of the ISP processing operations, including black level correction, WB adjustment, demosaicing, CCM, and global tone mapping. The downscale and simple processing block 110 performs the operations on the reduced-resolution image to produce a compact, 8-bit representation of the scene suitable for artificial intelligence (AI) inference. According to some examples, operating on the low-resolution image is computationally efficient because the harmonization task involves global adjustments to color, brightness, and contrast rather than spatially varying detail enhancement, and therefore does not depend on full-resolution image data.

A background image 108 is provided as a second input to the system 100, representing the virtual or synthetic background against which the foreground subject is to be composited. The background image 108 is passed through a downscale block 112, which reduces the background image 108 to the same spatial resolution as the output of the downscale and simple processing block 110, so that the two inputs are spatially commensurate for processing by the harmonization neural network 120.

The downscaled output of the downscale and simple processing block 110 is passed to a background/foreground segmentation block 115. The background/foreground segmentation block 115 applies a segmentation AI model to the low-resolution scene image to generate a pixel-level foreground mask that identifies which regions of the image correspond to the foreground subject (e.g., a person or an inserted object) and which regions correspond to the background. The foreground mask produced by the background/foreground segmentation block 115 is provided as an input to both the harmonization neural network 120 and the harmonization block 180.

According to various implementations, the harmonization neural network 120 receives three inputs: the downscaled scene image from the downscale and simple processing block 110, the downscaled background image from the downscale block 112, and the foreground mask from the background/foreground segmentation block 115. Based on these inputs, the harmonization neural network 120 predicts the ISP hardware block parameter corrections that, when applied to the primary full-resolution processing path, will cause the foreground region of the processed image to match the visual characteristics of the background image 108. In some examples, the visual characteristics that are matched can include color temperature, brightness, and contrast. In the adaptive real-time ISP harmonization system 100 of FIG. 1, the harmonization neural network 120 outputs three sets of predicted parameter corrections: WB parameter corrections, CCM parameter corrections, and TM parameter corrections. In some examples, the total harmonized TM response

$${f}_{TM}^{H} ( luma )$$

applied by the TM block 145 can be expressed as:

$${f}_{TM}^{H} ( luma ) = {f}_{TM} ( luma ) \cdot {f}_{TM}^{Δ H} ( luma ) \qquad ( 1 )$$

where f_{TM} (luma) is the original TM response derived from ISP scene statistics, and

$${f}_{TM}^{Δ H} ( luma )$$

is the multiplicative correction curve predicted by the harmonization neural network 120 for the harmonization of the foreground region. The product

$${f}_{TM}^{H} ( luma )$$

represents the total TM response that harmonizes the brightness and contrast of the foreground region to match those of the background image 108, and is implementable as a lookup table within the same TM block 145 hardware without modification.

The predicted parameter corrections output by the harmonization neural network 120 are passed to the blend parameters control block 150 alongside the corresponding raw WB parameters 155, raw CCM parameters 160, and raw TM parameters 165. The raw WB parameters 155, raw CCM parameters 160, and raw TM parameters 165 represent the original ISP hardware block configurations as derived from the ISP's statistics aggregation and scene analysis, reflecting the actual illumination of the captured scene. The blend parameters control block 150 interpolates between the raw parameters and the predicted parameter corrections using a scalar blending factor alpha, which ranges from zero to one and is supplied to the blend parameters control block 150 as a harmonization adaptation strength signal. When the harmonization adaptation strength is zero, the blend parameters control block 150 passes the raw parameters unchanged; when the harmonization adaptation strength is one, the blend parameters control block 150 applies the full AI-predicted correction. Thus, in some examples, the blend parameters control block 150 controls the strength of the harmonization effect to be applied by blending the raw parameters with the predicted parameter corrections, using the following equation:

$${P}_{b}^{H} = α {P}_{b} + ( 1 - α ) {P}_{b}^{Δ H} \qquad ( 2 )$$

Where 0≤α≤1, where b is the relevant block (WB, CCM, TM), P_{b} represents the original ISP parameter set for block b as derived from scene statistics,

$${P}_{b}^{Δ H}$$

represents the harmonization parameter correction predicted by the harmonization neural network 120, and a is the harmonization adaptation strength. When a equals one, the blend parameters control block 150 passes the raw parameters P_{b} unchanged and no harmonization is applied. When α equals zero, the blend parameters control block 150 applies the full AI-predicted correctio

$${P}_{b}^{Δ H} .$$

Intermediate values of α produce a proportional blend between the two parameter sets.

The blend parameters control block 150 outputs adaptive WB parameters to the WB block 135, adaptive CCM parameters to the CCM block 140, and adaptive TM parameters to the TM block 145, thereby configuring the primary full-resolution hardware blocks to produce a processed image in which the foreground is harmonized to the background image 108.

In some examples, in automatic mode, the ISP leverages its existing face detection and skin tone statistics aggregation capabilities to constrain a such that the resulting skin tones of harmonized faces remain within the natural range of hue, saturation, and brightness. In some examples, constraining a in such a manner prevents both over-harmonization (where skin becomes unnaturally saturated or hue-shifted) and under-harmonization (where the correction is too weak to achieve a convincing result). In some examples, the mechanism is also semantically aware. In particular, because the AI model understands that skin tones occupy a constrained region of color space while non-person objects may occupy a much broader range, it can apply differentiated harmonization strengths to objects of different semantic classes even when the objects share similar initial colors.

The processed image output by the ISP pipeline 125 is an image in which the foreground region has been rendered with the harmonization corrections applied. The processed image is output to the harmonization block 180. The harmonization block 180 also receives the foreground segmentation map from the background/foreground segmentation block 115 and the background image 108. The harmonization block 180 composites the harmonized foreground region from the processed image with the background image 108 by blending the two according to the segmentation map. Specifically, the harmonized composition I_{C} output by the harmonization block 180 is expressed as:

$${I}_{C} = {mask}_{F} \cdot {I}_{H} + ( 1 - {mask}_{F} ) \cdot {I}_{B} \qquad ( 3 )$$

Where I_{H} is the harmonized processed image output of the ISP pipeline 125, I_{B} is the background image 108, and mask_{F} is the foreground segmentation mask produced by the background/foreground segmentation block 115. Pixels at locations where mask_{F} equals one (i.e., foreground pixels) are drawn from the harmonized processed image I_{H}, and pixels at locations where mask_{F} equals zero (i.e., background pixels) are drawn from the background image I_{B} 108. The result is output from the harmonization block 180 as the harmonized composition 190, in which the foreground subject is embedded within the synthetic background in a visually coherent and natural manner with respect to color, brightness, and contrast.

The blending mask can be a soft mask with values ranging from 0 to 1. For example, the blending mask can be a probabilistic map of the foreground segmentation. Because the blending mask is soft, the transition from the harmonized foreground to the synthetic background is gradual and smooth.

The adaptive ISP harmonization system 100 is thus configured to perform harmonization within or in coordination with the ISP pipeline 125, using existing hardware blocks and a lightweight AI model operating on low-resolution inputs. The architecture enables harmonization at full sensor bit depth, and leverages the ISP's built-in low-resolution processing path for computational efficiency. Additionally, the system 100 allows the harmonization adaptation strength supplied to the blend parameters control block 150 to be determined either manually or automatically based on scene statistics, such as skin tone measurements derived from face detection within the ISP pipeline 125. Furthermore, the adaptive ISP harmonization system 100 avoids the quantization artifacts associated with post-processing on 8-bit rendered images.

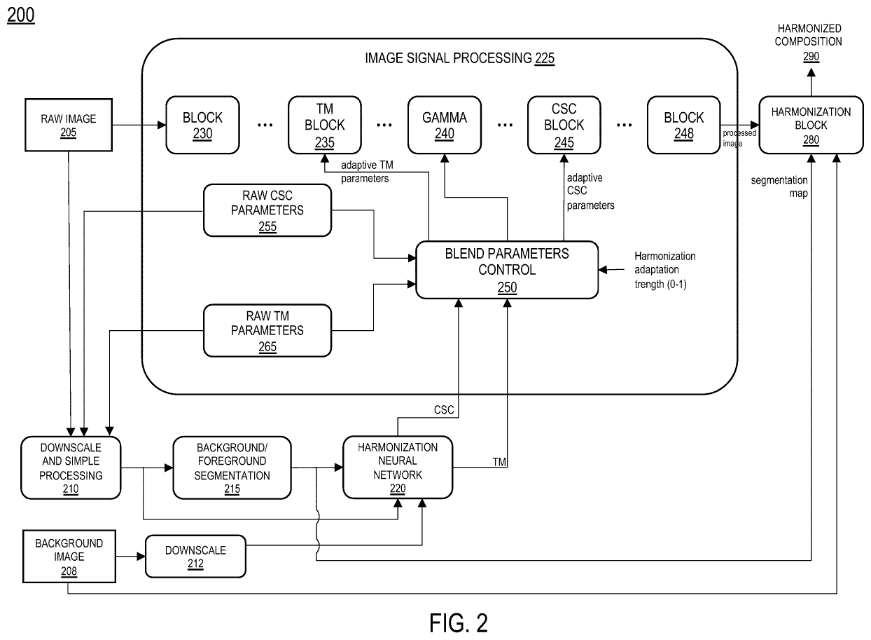

FIG. 2 is a block diagram of a post-color adaptive real-time ISP harmonization system 200, including an image signal processing (ISP) pipeline 225, in accordance with various embodiments. The ISP pipeline 225 receives a raw image 205 from a camera sensor as its primary input. The raw image 205 is an unprocessed sensor output capturing the scene at full bit depth, typically 10-16 bits or higher in HDR configurations. The raw image 205 is routed along two parallel processing paths within the system 200: a primary full-resolution processing path through the ISP pipeline 225, and a parallel low-resolution processing path beginning at the downscale and simple processing block 210. The post-color adaptive real-time ISP harmonization system 200 depicted in FIG. 2 implements a post-color reproduction harmonization configuration, in which harmonization is performed after the core color reproduction operations of the ISP pipeline 225 have been applied, by manipulating the TM block 235 and the CSC block 245 rather than the WB and CCM and TM blocks used in the color reproduction harmonization configuration of FIG. 1.

The primary full-resolution processing path within the ISP pipeline 225 includes a series of hardware blocks arranged in sequence. The pipeline 225 begins with block 230, which performs early-stage operations, such as black level correction and demosaicing. Downstream of block 230, a TM block 235 adjusts the brightness and contrast of the image by applying tone mapping operations, which can include both global tone mapping and local tone mapping. In some examples, global tone mapping includes a tone curve being applied uniformly across the image as a function of each pixel's luma value. In some examples, the harmonization corrections applied by the blend parameters control block 250 address the global tone mapping component of the TM block 235. In some examples, the TM block 235 receives adaptive global tone mapping parameters from the blend parameters control block 250. A gamma block 240 performs gamma correction downstream of the TM block 235, applying a standard perceptual transfer function to the image data. A CSC block 245 is positioned downstream of the gamma block 240 and performs a color space conversion from RGB to YUV representation, separating luminance information from chrominance information to enable more efficient downstream processing and encoding. In various examples, a further block 248 performs any remaining downstream processing operations before the processed image is passed out of the ISP pipeline 225 to the harmonization block 280.

The parallel low-resolution processing path begins at the downscale and simple processing block 210, which receives the raw image 205 and produces a downscaled version of the scene. In some examples, the downscaled version of the scene is downscaled at a reduction ratio of 1/8, by applying pixel binning. The downscale and simple processing block 210 performs a simplified version of the ISP processing operations on the reduced-resolution image to produce a compact, 8-bit representation of the scene suitable for AI inference. In some examples, operating on the low-resolution image is computationally efficient because the harmonization task involves global adjustments to color, brightness, and contrast rather than spatially varying detail enhancement, and therefore does not depend on full-resolution image data.

Similar to the adaptive real-time ISP harmonization system 100, a background image 208 is provided as a second input to the post-color adaptive real-time ISP harmonization system 200, representing the virtual or synthetic background against which the foreground subject is to be composited. The background image 208 is passed through a downscale block 212, which reduces it to the same spatial resolution as the output of the downscale and simple processing block 210, so that the two inputs are spatially commensurate for processing by the harmonization neural network 220.

The downscaled output of the downscale and simple processing block 210 is passed to a background/foreground segmentation block 215. The background/foreground segmentation block 215 applies a segmentation AI model to the low-resolution scene image to generate a pixel-level foreground mask that identifies which regions of the image correspond to the foreground subject and which regions correspond to the background. The foreground mask produced by the background/foreground segmentation block 215 is provided as an input to both the harmonization neural network 220 and the harmonization block 280.

The harmonization neural network 220 receives three inputs: the downscaled scene image from the downscale and simple processing block 210, the downscaled background image from the downscale block 212, and the foreground mask from the background/foreground segmentation block 215. Based on these inputs, the harmonization neural network 220 predicts the ISP hardware block parameter corrections that, when applied to the primary full-resolution processing path, will cause the foreground region of the processed image to match the visual characteristics of the background image 208. The visual characteristics can include color temperature, brightness, and contrast. In the post-color reproduction harmonization configuration shown in FIG. 2, the harmonization neural network 220 outputs two sets of predicted parameter corrections, labeled TM and CSC respectively, directed at the TM block 235 and the CSC block 245. In some examples, the total harmonized TM response applied by the TM block 235 is expressed as described with respect to equation (1). In some examples, the total harmonized global tone mapping response is implemented as a lookup table within the TM block 235 that maps a gain value to be applied to each pixel as a function of that pixel's luma value, applied uniformly across the image. In some examples, the total harmonized CSC matrix

$${M}_{CSC}^{H}$$

applied by the CSC block 245 is expressed as:

$${M}_{CSC}^{H} = {M}_{CSC} \cdot {M}_{CSC}^{Δ H} \qquad ( 4 )$$

Where M_{CSC} is the standard RGB-to-YUV conversion matrix (e.g., BT.601 or BT.709, etc.), and

$${M}_{CSC}^{Δ H}$$

is a 3×3 RGB-to-RGB color mapping matrix predicted by the harmonization neural network 220. In various examples, the matrix

$${M}_{CSC}^{H}$$

is a combined transform that performs both color harmonization and color space conversion in a single 3×3 matrix operation, and is configured into the CSC block 245 in place of the standard conversion matrix, with no additional hardware operations.

The predicted parameter corrections output by the harmonization neural network 220 are passed to the blend parameters control block 250 alongside the corresponding raw TM parameters 265 and raw CSC parameters 255. The raw TM parameters 265 and raw CSC parameters 255 represent the original ISP hardware block configurations as derived from the ISP's own statistics aggregation and scene analysis, reflecting the actual illumination of the captured scene. The blend parameters control block 250 interpolates between the raw parameters and the AI-predicted parameters using a scalar blending factor alpha, which ranges from zero to one and is supplied to the blend parameters control block 250 as a harmonization adaptation strength signal. In various examples, for a given hardware block b, the blended output parameter set produced by the blend parameters control block 250 is expressed as described with respect to equation (2).

When the foreground region includes a human face, the blend parameters control block 250 exploits face detection and skin tone statistics aggregation capabilities of the ISP pipeline 225 to evaluate the predicted skin tone hue, saturation, and brightness values that would result from application of the blended parameter set

$${P}_{b}^{H}$$

to the CSC block 245, and constrains a such that those values remain within the natural range for human skin tones, thereby preventing over-harmonization or under-harmonization of the foreground subject.

The blend parameters control block 250 outputs adaptive TM parameters to the TM block 235 and adaptive CSC parameters to the CSC block 245, thereby configuring the primary full-resolution hardware blocks to produce a processed image in which the foreground is harmonized to the background image 208.

The processed image output by the ISP pipeline 225, in which the foreground region has been rendered with the harmonization corrections applied, is passed to the harmonization block 280. The harmonization block 280 also receives the foreground segmentation map from the background/foreground segmentation block 215 and the background image 208. The harmonization block 280 composites the harmonized foreground region from the processed image with the background image 208 by blending the two according to the segmentation map. Specifically, the harmonized composition output by the harmonization block 280 is expressed as described above with respect to equation (3).

According to various implementations, the post color adaptive real-time ISP harmonization system 200 is thus configured to perform post color reproduction harmonization within or in coordination with the ISP pipeline 225, using existing hardware blocks and a lightweight AI model operating on low-resolution inputs. In some examples, by positioning the harmonization corrections at the TM block 235 and CSC block 245 (i.e., after the core color reproduction operations have been applied), the post color reproduction harmonization configuration of FIG. 2 can provide a simpler training data acquisition process relative to the configuration of FIG. 1. In some examples, the gamma and CSC operations applied by the ISP pipeline 225 are well-defined transforms that can be readily inverted during training data generation, without dependence on image-specific metadata. The harmonization adaptation strength a supplied to the blend parameters control block 250 may be determined either manually or automatically based on scene statistics such as skin tone measurements derived from face detection within the ISP pipeline 225, constraining the blended parameter set

$${P}_{b}^{H}$$

such that predicted skin tone hue, saturation, and brightness values remain within the natural range and preventing over-harmonization or under-harmonization of the foreground subject.

### Example Harmonization Neural Network Architecture

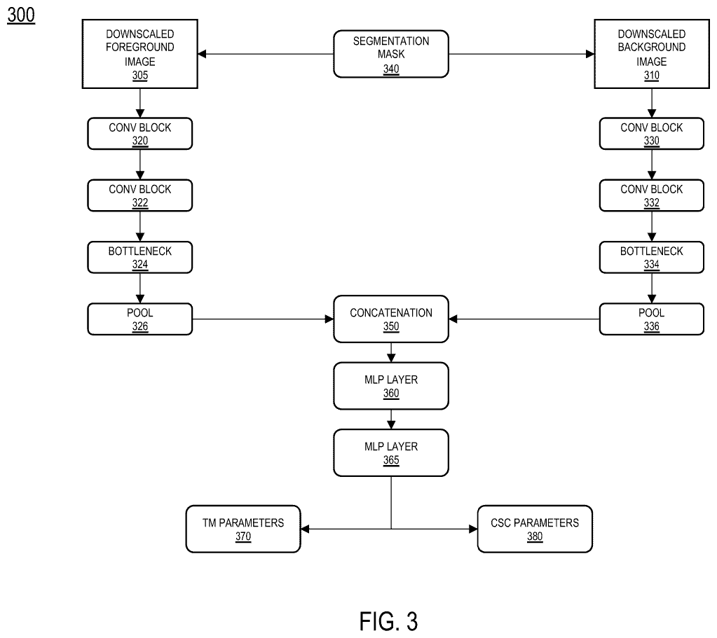

FIG. 3 is a block diagram of a harmonization neural network architecture 300, in accordance with various embodiments. The harmonization neural network architecture 300 receives three inputs: a downscaled foreground image 305, a downscaled background image 310, and a segmentation mask 340. The downscaled foreground image 305 and the downscaled background image 310 are low-resolution representations of the foreground scene and the selected synthetic background, respectively. In some examples, the foreground scene and the selected synthetic background are each downscaled by a factor of 1/8 relative to the full-resolution image. In some examples, the foreground scene and the background are each downscaled relative to the full-resolution image by one of a factor of 2, a factor of %, a factor of 1/6, a factor of 1/10, a factor of 1/12, or any other selected factor. The downscaled foreground image 305 and the downscaled background image 310 can be produced by the parallel low-resolution processing path of the ISP pipeline as described with respect to FIGS. 1 and 2. The segmentation mask 340 is a pixel-level binary map identifying the foreground and background regions of the scene, as produced by the background/foreground segmentation block of the ISP pipeline. Processing the downscaled foreground image 305 and the downscaled background image 310 at low resolution is computationally efficient because the harmonization task involves global adjustments to color, brightness, and contrast, and therefore does not depend on fine spatial detail present in the full-resolution image.

According to various implementations, the downscaled foreground image 305 and the downscaled background image 310 are each processed by independent feature extraction branches. In some examples, the independent feature extraction branches can be architecturally identical. The foreground branch includes a convolutional block 320, a convolutional block 322, a bottleneck block 324, and a pool block 326, arranged in series. Similarly, the background branch comprises a convolutional block 330, a convolutional block 332, a bottleneck block 334, and a pool block 336, arranged in series. The convolutional block 320 and convolutional block 330 apply learned convolutional filters to extract low-level spatial features from the downscaled foreground image 305 and the downscaled background image 310, respectively. The convolutional block 322 and convolutional block 332 apply a further stage of convolutional filtering to extract progressively higher-level features. The bottleneck block 324 and bottleneck block 334 apply a compact bottleneck convolution operation to produce a compressed feature representation while reducing computational cost. The pool block 326 and pool block 336 apply global average pooling to the output of the bottleneck block 324 and bottleneck block 334, respectively, collapsing the spatial dimensions of the feature maps to produce a fixed-length embedding vector summarizing the global visual appearance of the downscaled foreground image 305 and the downscaled background image 310. Because the background image is fixed for the duration of a session, the feature extraction performed by the convolutional block 330, convolutional block 332, bottleneck block 334, and pool block 336 can be performed only once, and the resulting embedding is cached for reuse across subsequent frames, reducing redundant computation.

Prior to entry into their respective feature extraction branches, the segmentation mask 340 (M) is concatenated with the downscaled foreground image 305, and the inverse of the segmentation mask 340 (1-M) is concatenated with the downscaled background image 310. In this way, the segmentation mask 340 spatially guides the foreground feature extraction branch to extract features from the foreground region of the downscaled foreground image 305, and the inverse of the segmentation mask 340 spatially guides the background feature extraction branch to extract features from the background region of the downscaled background image 310, directing each branch to extract global appearance features from the relevant region of its respective input. The embedding vector produced by the pool block 326 and the embedding vector produced by the pool block 336 are jointly provided to a concatenation block 350. In various examples, the concatenation block 350 combines these two inputs into a single unified feature vector that encodes the global visual characteristics of both the foreground and the background, as guided by the segmentation mask 340 (M) and the inverse segmentation mask 340 (1-M), respectively. The unified feature vector enables the subsequent MLP layers to reason about the relationship between the foreground appearance and the background appearance in the context of the foreground region, and to predict harmonization corrections that are appropriately differentiated based on the semantic content of the foreground, such as applying different corrections to skin tones than to non-person objects of similar color.

The concatenated feature vector output by the concatenation block 350 is passed through two successive fully connected layers: an MLP layer 360 and an MLP layer 365. The MLP layer 360 and MLP layer 365 each apply a learned linear transformation followed by a non-linear activation function, progressively mapping the concatenated feature representation to a compact set of ISP hardware block configuration parameters. The MLP layer 365 produces a final output that is split into two sets of predicted parameter corrections: TM parameters 370 and CSC parameters 380. The TM parameters 370 comprise the coefficients of the multiplicative tone mapping correction curve, which can be applied to the TM block of the ISP pipeline 225 to harmonize the brightness and contrast of the foreground region to match those of the background. The CSC parameters 380 comprise the nine coefficients of the 3×3 RGB-to-RGB color mapping matrix, which can be incorporated into the CSC block of the ISP pipeline 225 to harmonize the color appearance of the foreground region to match that of the background. Both the TM parameters 370 and the CSC parameters 380 are passed to the blend parameters control block of the ISP pipeline, where they are interpolated with the original ISP parameters according to the harmonization adaptation strength before being applied to the corresponding ISP hardware blocks.

### Example Blend Parameter Generation

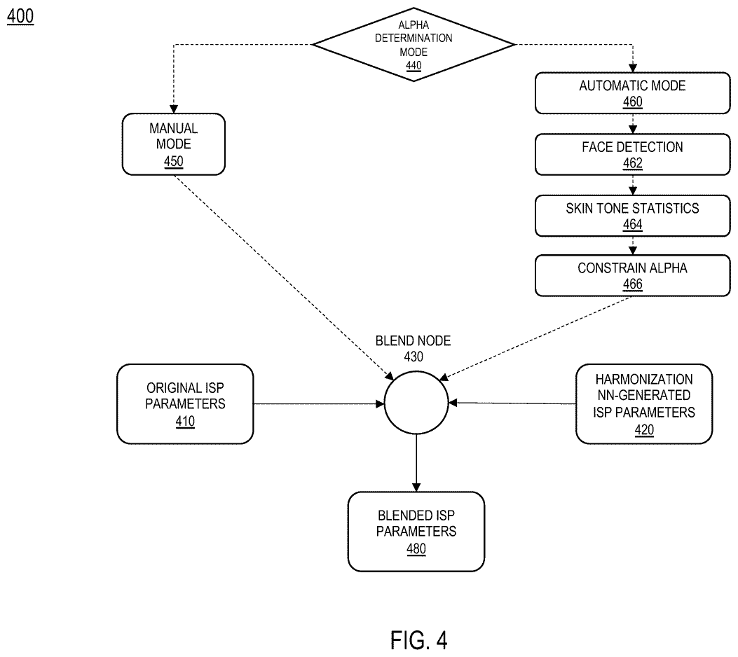

FIG. 4 is a block diagram 400 illustrating blend parameter generation, in accordance with various embodiments. In particular, the blend parameter generation can be used for determining and applying a harmonization adaptation strength to ISP hardware block parameters. The blend parameter control flow can be used to determine how the original ISP parameters 410, derived from the ISP's own statistics aggregation and scene analysis, are combined with the harmonization neural network-generated ISP parameters 420, predicted by the harmonization neural network, to produce blended ISP parameters 480 that are applied to the corresponding ISP hardware blocks. The interpolation between the original ISP parameters 410 and the harmonization neural network-generated ISP parameters 420 is performed at a blend node 430 using a scalar blending factor alpha, which ranges from zero to one. The value of alpha is determined by an alpha determination mode 440, which selects between two operating modes: a manual mode 450 and an automatic mode 460, each of which supplies a value of alpha to the blend node 430 via a respective path as shown in FIG. 4.

In the manual mode 450, the value of alpha is set directly by a user or ISP calibrator. The manual mode provides explicit control over the strength of the harmonization effect, allowing the degree of blending between the original ISP parameters 410 and the harmonization neural network-generated ISP parameters 420 to be fixed at a predetermined level. The manual mode 450 can be used in scenarios in which the desired harmonization strength is known in advance or where a fixed, consistent effect across varying scene conditions is preferred. The value of alpha determined by the manual mode 450 is supplied to the blend node 430, where it governs the interpolation between the original ISP parameters 410 and the harmonization neural network-generated ISP parameters 420.

In the automatic mode 460, the value of alpha is determined dynamically based on scene content statistics aggregated by the ISP pipeline. The automatic mode 460 includes a sequence of operations, including face detection 462, skin tone statistics 464, and constrain alpha 466. The face detection 462 operation identifies the presence and location of a human face within the foreground region of the scene, using face detection capabilities already present within the ISP pipeline. Where a face is detected, the skin tone statistics 464 operation aggregates statistical descriptors of the skin tone pixels within the detected face region, including measurements of hue, saturation, and brightness. The skin tone statistics characterize the current color appearance of the foreground subject's skin and are used to predict what the skin tone hue, saturation, and brightness values would be following application of a candidate set of blended ISP parameters 480 at a given value of alpha. The constrain alpha 466 operation determines the value of alpha that keeps the predicted skin tone hue, saturation, and brightness values within the natural range for human skin tones, preventing over-harmonization and under-harmonization. In various examples, over-harmonization results in the foreground subject's skin tones becoming unnaturally shifted toward the color temperature of the background, while under-harmonization results in insufficient correction being applied and the foreground subject remaining visually inconsistent with the background. The value of alpha produced by the constrain alpha 466 operation is supplied to the blend node 430 when the automatic mode 460 is selected by the alpha determination mode 440.

At the blend node 430, the original ISP parameters 410 and the harmonization neural network-generated ISP parameters 420 are interpolated according to the value of alpha supplied by either the manual mode 450 or the automatic mode 460, producing the blended ISP parameters 480. For a given hardware block b, the blended ISP parameters 480 are expressed as described with respect to equation (2), where P_{b} represents the original ISP parameters 410,

$${P}_{b}^{Δ H}$$

represents the harmonization neural network-generated ISP parameters 420, and α is the harmonization adaptation strength. The blended ISP parameters 480 produced by the blend node 430 can be applied to the corresponding ISP hardware blocks, such as the WB block, CCM block, and TM block in the color reproduction harmonization configuration of FIG. 1, or the TM block and the CSC block in the post color reproduction harmonization configuration of FIG. 2, to configure the ISP pipeline to produce a harmonized output image in which the foreground region is naturally embedded within the selected background.

### Example Harmonization Parameter Determination Process

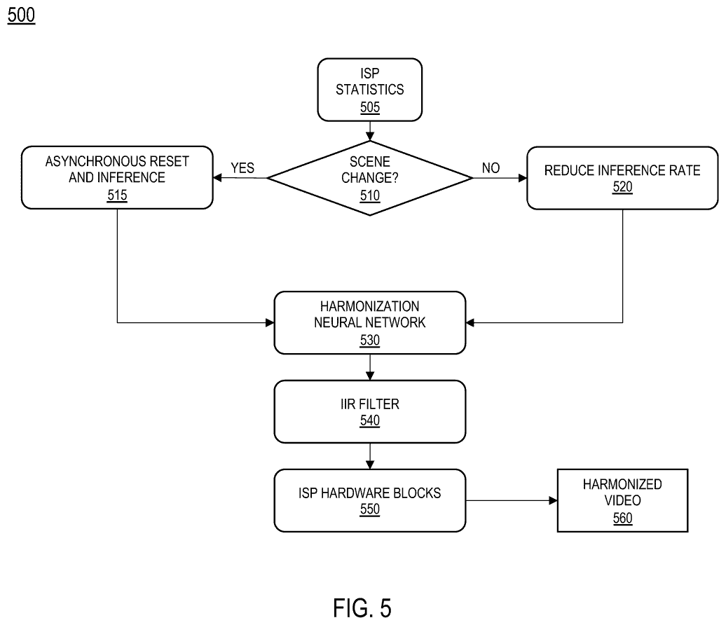

FIG. 5 is a flow diagram 500 of a harmonization parameter determination process in a video processing pipeline, in accordance with various embodiments. In various examples, the harmonization parameter determination process is applied to the processing of the raw input image (e.g., raw image 105, raw image 205) of a video stream. In some examples, the process can be driven by ISP statistics 505, which are continuously aggregated by dedicated hardware blocks within the ISP pipeline and reflect the current illumination, color temperature, and intensity characteristics of the captured scene. In some examples, the ISP statistics 505 are monitored on a per-frame basis and serve as the input to a scene change decision 510, which determines whether a significant change in scene conditions has occurred since the previous inference. In some examples, continuous monitoring allows the control flow to adapt the harmonization inference schedule dynamically in response to changes in the scene, balancing computational efficiency against the timeliness of harmonization parameter updates.

As shown in FIG. 5, the scene change decision 510 produces one of two outcomes. If a significant scene change is detected (e.g., the user has moved the camera to a different lighting environment, or a sudden change in ambient illumination has occurred), the scene change decision 510 proceeds to the asynchronous reset and inference block 515. The asynchronous reset and inference block 515 resets the harmonization parameter state and triggers an unscheduled inference of the harmonization neural network 530, ensuring that the harmonization parameters are promptly updated to reflect the new scene conditions without waiting for the next scheduled inference event. If no significant scene change is detected at the scene change decision 510, the scene change decision 510 proceeds to the reduce inference rate block 520. The reduce inference rate block 520 schedules the next inference of the harmonization neural network 530 at a reduced rate relative to the video frame rate, exploiting the fact that in controlled illumination environments (e.g., indoor office or home settings typical of video conferencing), the global appearance of the scene changes slowly relative to the camera frame rate. For example, where the video frame rate is 30 frames per second, the reduce inference rate block 520 may schedule harmonization inference at a rate as low as 5 frames per second or less, reducing the computational and power burden of the harmonization neural network 530 by a factor of six or more relative to per-frame inference.

Both the asynchronous reset and inference block 515 and the reduce inference rate block 520 supply inputs to the harmonization neural network 530, which predicts the ISP hardware block parameter corrections for the current frame based on the downscaled foreground image, the downscaled background image, and the foreground segmentation mask. Because the harmonization neural network 530 is invoked at a reduced rate by the reduce inference rate block 520, raw parameter predictions are available only at inference events and not at every video frame. Thus, the predicted parameters output by the harmonization neural network 530 are passed to an IIR filter 540, which applies temporal smoothing across frames to generate a stable per-frame parameter estimate. In some examples, the IIR filter 540 operates according to the following equation:

$${P}_{b}^{FH} = β \cdot {P}_{b}^{H} ( t ) + ( 1 - β ) \cdot {P}_{b}^{H} ( t - T ) \qquad ( 5 )$$

$$where {P}_{b}^{H} ( t )$$

is the current parameter prediction from the harmonization neural network 530,

$${P}_{b}^{H} ( t - T )$$

is the previous smoothed parameter estimate, T is the inference period, and β is the IIR smoothing factor. According to various examples, between inference events, the IIR filter 540 continues to produce a smoothed output at every video frame by weighting the most recent prediction from the harmonization neural network 530 against the accumulated history of prior predictions. Thus, the IIR filter 540 can prevent abrupt parameter changes and suppress flickering artifacts that would otherwise arise from frame-to-frame noise in the raw predictions of the harmonization neural network 530. In some examples, the smoothing factor β is controlled dynamically by the ISP statistics 505 software, which adjusts the degree of smoothing in response to the rate of change of scene conditions. In some examples, a lower value of β applies heavier smoothing under stable illumination, while a higher value of β allows the IIR filter 540 to respond more rapidly to genuine changes in scene appearance.

In various examples, the smoothed parameter estimates generated by the IIR filter 540 are applied at every video frame to the ISP hardware blocks 550. The ISP hardware blocks can include blocks configured for harmonization, such as the WB block, the CCM block, the TM block, and the CSC block, as described above with respect to FIGS. 1 and 2. In various examples, by applying the smoothed parameters from the Ilk filter 540 to the ISP hardware blocks 550 at the full video frame rate, the harmonized video 560 output by the ISP hardware blocks 550 is updated at every frame with a temporally stable and artifact-free parameter set, even though the harmonization neural network 530 itself is invoked at a substantially lower rate. The decoupling of the inference rate from the video frame rate (enabled by the IIR filter 540) allows the computational cost of the harmonization neural network 530 to be spread across multiple frames without degrading the temporal quality of the harmonized video 560.

The harmonized video 560 generated by the ISP hardware blocks 550 represents an output in which each frame of the video stream contains a foreground region that has been harmonized to the selected background with a temporally smooth and visually consistent appearance. The process thus achieves a balance between computational efficiency, temporal stability, and responsiveness to scene changes. Under stable illumination conditions, inference is performed infrequently and smoothing is applied heavily by the IIR filter 540 to minimize power consumption, while under changing illumination conditions, the scene change decision 510 triggers the asynchronous reset and inference block 515 to restore accurate harmonization without perceptible delay in the harmonized video 560.

### Example ISP Harmonization System Training Data

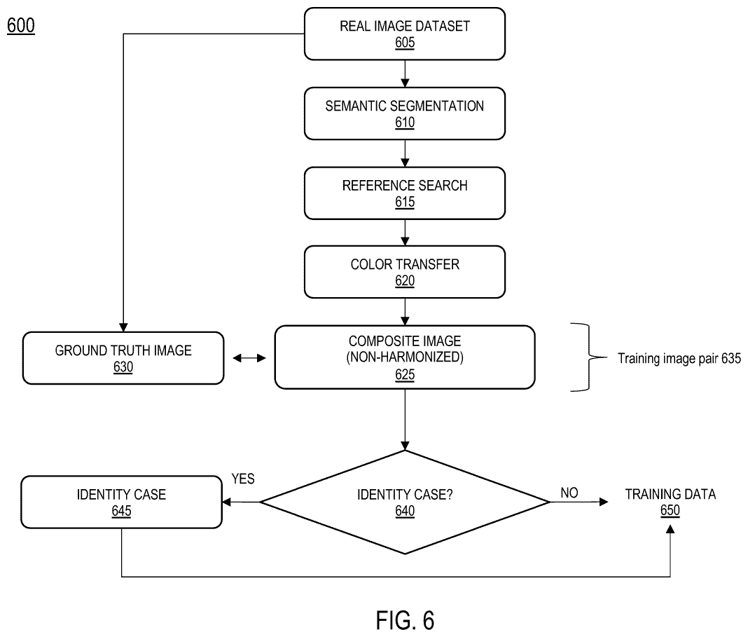

FIG. 6 is a block diagram of a training data generation pipeline 600 for generating a dataset of image pairs for use in supervised training of the harmonization neural network of the adaptive real-time ISP harmonization system, in accordance with various embodiments. The training data generation pipeline 600 produces pairs of composite (non-harmonized) input images and harmonized ground truth images from which the harmonization neural network learns to predict ISP hardware block parameter corrections that map a non-harmonized foreground appearance to a naturally harmonized one. The pipeline 600 exploits the property that any image captured by a camera under a single consistent illumination is harmonized by definition, because the foreground subject and the background are lit by the same light source and have therefore undergone the same color temperature, brightness, and contrast conditions. Real images from a real image dataset 605 can thus serve as ground truth targets 630 without any additional manual annotation.

The training data generation pipeline 600 begins with the real image dataset 605, which includes a large collection of images and videos captured across a variety of indoor and outdoor lighting conditions. Because each image in the real image dataset 605 depicts a scene under consistent illumination, the foreground and background regions of each image are naturally harmonized with respect to color temperature, brightness, and tonal appearance. In various examples, the real image dataset 605 spans a wide range of lighting conditions to ensure that the harmonization neural network is trained on a sufficiently diverse set of appearance transformations. In some examples, the real image dataset 605 can include publicly available datasets as well as internally collected images and videos.

For each image in the real image dataset 605, a semantic segmentation block 610 identifies and isolates a target foreground object or region of interest, such as a person, animal, or object, by applying a semantic segmentation model to the image. The semantic segmentation block 610 produces a soft foreground mask delineating the target foreground region from the surrounding background. The mask accompanies the image through the remainder of the training data generation pipeline 600 and is subsequently used during training to confine the loss computation to the foreground region, ensuring that the harmonization neural network is trained to correct the foreground appearance and is not penalized for differences in the background region.

Using the target foreground object and its mask as identified by the semantic segmentation block 610, a reference search block 615 searches the real image dataset 605 to locate a reference image containing a semantically matched object. The semantically matched object can be an object belonging to the same semantic class as the target foreground object, such as another person or another car, but captured under a meaningfully different illumination condition. In some examples, having the reference object belong to the same semantic class as the target object ensures that the color transfer applied in the subsequent step produces a plausible and semantically consistent appearance change. In some examples, if the reference object belonged to a different semantic class than the target object, the color transfer applied in the subsequent step can result in an arbitrary and/or physically implausible appearance change. For example, a person's skin tones may be transferred to reflect the warmer illumination of an outdoor scene, generating a foreground appearance that is realistic in isolation but inconsistent with the cooler illumination of the target image's background.

A color transfer block 620 determines a transformation function that maps the color and luminance appearance of the target foreground object to match the appearance of the reference object identified by the reference search block 615. In particular, the color transfer block 620 can determine luminance statistics and color temperature statistics from the masked foreground regions of both the target image and the reference image, and the color transfer block 620 can apply a histogram matching method to derive the color transfer function. The color transfer function is applied exclusively to the foreground region of the target image, as defined by the mask generated by the semantic segmentation block 610, leaving the background pixels of the target image unmodified. The result is a composite image (non-harmonized) 625 in which the foreground object's appearance reflects the lighting characteristics of a different scene while the background retains the original illumination of the target image, thereby replicating the type of foreground-background lighting mismatch that occurs in real-world background replacement and content editing scenarios. The composite image (non-harmonized) 625 and the corresponding original real image from the real image dataset 605, designated as the ground truth 630, together constitute a training image pair 635, as indicated in FIG. 6. The ground truth 630 represents the target output that the harmonization neural network is trained to reconstruct from the composite image (non-harmonized) 625 by predicting the appropriate ISP hardware block parameter corrections.

The composite image (non-harmonized) 625 can be directed to an identity case decision block 640, which determines whether the current training sample is designated as an identity case. For an identity case, the ground truth 630 is used directly as the composite input to the harmonization neural network in place of the composite image (non-harmonized) 625. In some examples, the identity case decision block 640 directs the samples to an identity case block 645, such that the ground truth 630 is used directly as the composite input. In the identity cases, the foreground of the input image already matches the background by definition, and the harmonization neural network is therefore trained to output ISP parameters corresponding to identity operators (i.e., the output ISP parameters leave the image unchanged). In some examples, using a percentage of the training samples as identity cases is a regularization mechanism that prevents the harmonization neural network from learning to always apply a correction regardless of whether one is warranted. Additionally, using a percentage of the training samples as identity cases ensures that the trained network applies harmonization selectively and adaptively, intervening when a genuine appearance mismatch between foreground and background is present. In the remaining training samples, the identity case decision block 640 directs the composite image (non-harmonized) 625 and its corresponding ground truth 630 to become the training data 650 without modification.

In some examples, about 10% of training samples are designated as identity cases, and about 90% of training samples become the training data 650 without modification. In some examples, the percentage of training samples designated as identity cases is about 5%, about 8%, about 12%, about 15%, between about 5%-15%, less than about 5%, or more than 15%.

The training data 650 produced by the training data generation pipeline 600 thus comprises a mixture of non-harmonized composite and ground truth image pairs for the majority of samples, supplemented by identity case pairs, providing the harmonization neural network with a balanced and realistic training distribution that supports both accurate harmonization and appropriate restraint when the scene is already naturally harmonized.

### Example Method for Adaptive Real-Time ISP Harmonization

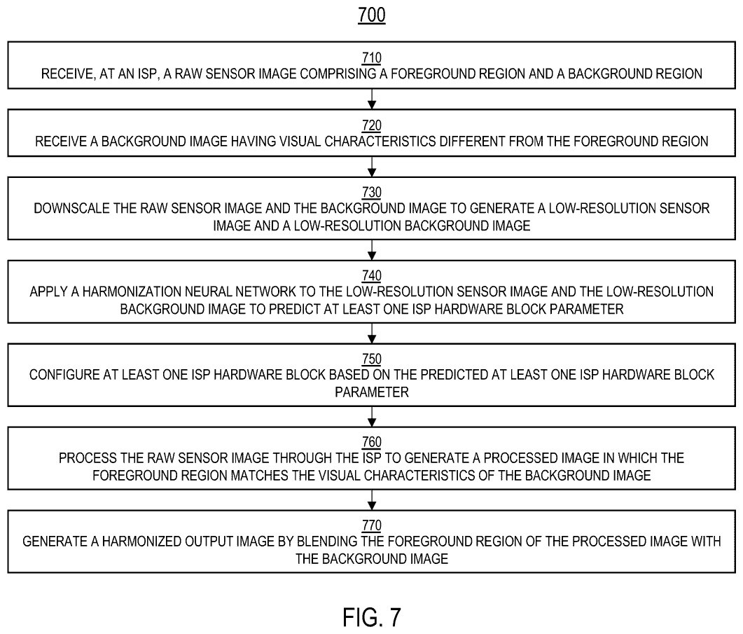

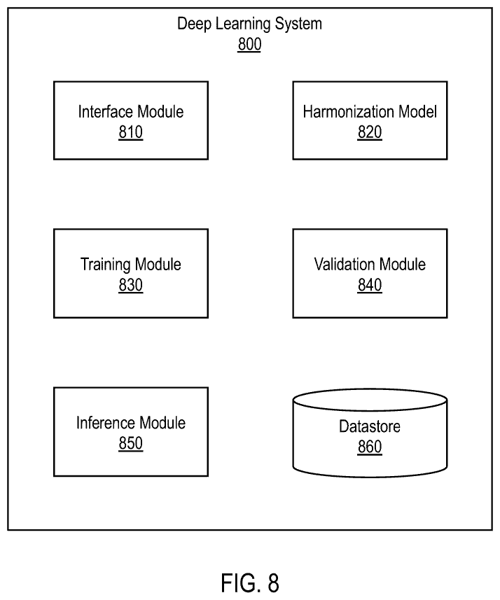

FIG. 7 is a flowchart showing a method 700 for adaptive real-time ISP harmonization, in accordance with various embodiments. In some examples, the method 700 may be used for background replacement and content editing. The method 700 may be performed by the systems 100, 200 of FIGS. 1 and 2, and/or by the deep learning system 800 in FIG. 8. Although the method 700 is described with reference to the flowchart illustrated in FIG. 7, other methods for harmonization may alternatively be used. For example, the order of execution of the steps in FIG. 7 may be changed. As another example, some of the steps may be changed, eliminated, or combined.

At 710, the method 700 includes receiving, at an ISP, a raw sensor image comprising a foreground region and a background region. The raw sensor image is an unprocessed sensor output captured at full bit depth, typically 10-16 bits or higher in HDR configurations. In various embodiments, the foreground region comprises a person segmented from a live camera scene for background replacement in a video call, or newly inserted content to be harmonized with respect to an original scene background.

At 720, the method 700 includes receiving a background image having visual characteristics different from the foreground region. The background image represents a virtual or synthetic background against which the foreground region is to be composited, and, in some examples, the background image differs from the foreground region in one or more of color temperature, brightness, contrast, and tonal appearance due to the foreground region and the background image having originated under different illumination conditions.

At 730, the method 700 includes downscaling the raw sensor image and the background image to generate a low-resolution sensor image and a low-resolution background image. In various embodiments, downscaling includes applying pixel binning at a downscale ratio of 1/8. Operating on downscaled images is computationally efficient because the harmonization task involves global adjustments to color, brightness, and contrast that do not depend on fine spatial detail present in the full-resolution image. In various embodiments, the method 700 further comprises generating a foreground segmentation mask identifying the foreground region within the raw sensor image, comprising applying a segmentation AI model to the low-resolution sensor image to produce a pixel-level soft map delineating the foreground region from the background region. The foreground segmentation mask can be used to confine harmonization corrections to the foreground region and to generate the harmonized output image.

At 740, the method 700 includes applying a harmonization neural network to the low-resolution sensor image and the low-resolution background image to predict at least one ISP hardware block parameter. In various examples, applying the harmonization neural network includes applying the harmonization neural network to the foreground segmentation mask in addition to the low-resolution sensor image and the low-resolution background image. In various examples, applying the harmonization neural network includes extracting a first feature embedding from the low-resolution sensor image and a second feature embedding from the low-resolution background image using independent feature extraction branches, each comprising multiple convolutional blocks, a bottleneck block, and a global average pooling block. In some examples, the background image is fixed for the duration of a session, and thus the second feature embedding is determined once and cached for reuse across multiple frames of the video stream, reducing redundant computation. In some examples, the foreground segmentation mask is concatenated with the low-resolution sensor image, and the inverse of the foreground segmentation mask is concatenated with the low-resolution background image, such that each feature extraction branch is guided to selectively extract features from the relevant region of its respective input. The first feature embedding and the second feature embedding are concatenated and passed through a multilayer perceptron (MVLP) to produce the predicted at least one ISP hardware block parameter. In various examples, the harmonization neural network applies semantically differentiated harmonization parameters to different foreground objects having similar initial colors based on the semantic class of each object, such that skin tone regions of a person are harmonized differently from non-person foreground objects of similar color. In various examples, the at least one ISP hardware block parameter comprises at least one of a tone mapping correction curve representing a multiplicative correction to an original tone mapping response derived from ISP scene statistics, or a color mapping matrix representing a 3×3 RGB-to-RGB color mapping correction to be incorporated into a color space conversion operation.

At 750, the method 700 includes configuring at least one ISP hardware block based on the predicted at least one ISP hardware block parameter. In various examples, the at least one ISP hardware block includes at least one of a white balance (WB) block, a color correction matrix (CCM) block, a tone mapping (TM) block, or a color space conversion (CSC) block.

In a first configuration, configuring the at least one ISP hardware block includes configuring the WB block, the CCM block, and the TM block to perform color reproduction harmonization of the foreground region. In a second configuration, configuring the at least one ISP hardware block includes configuring the TM block and the CSC block to perform post-color reproduction harmonization of the foreground region. Configuring the TM block can include determining a total harmonized tone mapping response by combining an original tone mapping response derived from ISP scene statistics with a multiplicative correction curve predicted by the harmonization neural network. The total harmonized tone mapping response can be applied to the TM block as a lookup table. In some examples, configuring the CSC block includes replacing a standard color space conversion matrix with a combined matrix that performs both a color mapping operation and a color space conversion from RGB to YUV in a single matrix operation.

In various embodiments, configuring the at least one ISP hardware block further includes blending the predicted ISP hardware block parameter with an original ISP hardware block parameter according to a blending factor ranging from zero to one. In some examples, a blending factor of one yields no harmonization and a blending factor of zero yields full application of the predicted ISP hardware block parameter. The blending factor may be set manually by a user, or determined automatically. Determining the blending factor automatically can include determining the blending factor based on skin tone statistics of a detected face in the foreground region. In the automatic mode, determining the blending factor can include applying face detection to the low-resolution sensor image to identify a face region within the foreground region, aggregating skin tone statistics from the identified face region, and constraining the blending factor to a value at which predicted skin tone hue, saturation, and brightness values resulting from application of the blended parameter remain within a predefined natural skin tone range, thereby preventing over-harmonization or under-harmonization of the foreground region.

At 760, the method 700 includes processing the raw sensor image through the ISP to generate a processed image in which the foreground region matches the visual characteristics of the background image. Because the raw sensor image is processed through the ISP at full bit depth prior to bit-depth reduction, the harmonization corrections are applied before quantization, thereby avoiding the quantization artifacts, banding, and posterization associated with harmonization performed on 8-bit post-processed images. In various examples, the method 700 includes managing the rate at which the harmonization neural network is invoked relative to the frame rate of the video stream. When no significant scene change is detected based on ISP statistics, the inference rate of the harmonization neural network is reduced below the video frame rate. When a significant scene change is detected, an asynchronous reset and immediate re-inference of the harmonization neural network is triggered. Between inference events, an infinite impulse response (IIR) filter is applied to successive predicted ISP hardware block parameters to generate a smoothed parameter estimate at every frame of the video stream, wherein the IIR smoothing factor and inference period are dynamically controlled based on ISP statistics, preventing flickering artifacts and reducing power consumption.

At 770, the method 700 includes generating a harmonized output image by blending the foreground region of the processed image with the background image. In various examples, generating the harmonized output image includes, for each pixel of the harmonized output image, selecting a pixel value from the processed image where the foreground segmentation mask identifies the pixel as belonging to the foreground region, and selecting a pixel value from the background image where the foreground segmentation mask identifies the pixel as belonging to the background region. In various examples, the foreground segmentation mask is a soft mask with values ranging from 0 to 1, for example a probabilistic map of the foreground segmentation, such that each pixel of the harmonized output image is determined as a weighted blend of the corresponding pixel values from the processed image and the background image according to the soft mask value at that pixel location. Because the foreground segmentation mask is soft, the transition from the harmonized foreground to the background image is gradual and smooth, avoiding hard edges at the boundary between the foreground region and the background image. The resulting harmonized output image includes a foreground region that is naturally embedded within the background image with respect to color temperature, brightness, and contrast, producing a visually coherent and believable composition free of the artificial cut-out effect characteristic of prior art background replacement solutions.

### Example DNN System for Harmonization

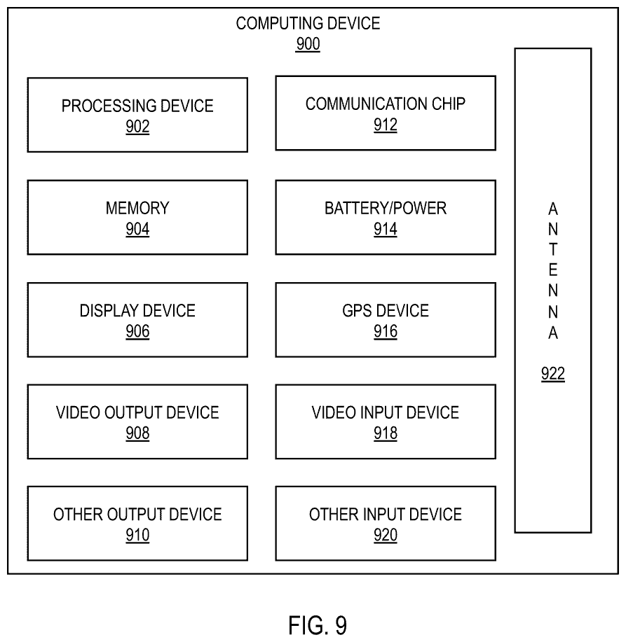

FIG. 8 is a block diagram of an example DNN system 800, in accordance with various embodiments. The DNN system 800 trains DNNs for various tasks, including harmonization between input image frames of a video stream and background images. The DNN system 800 includes an interface module 810, a harmonization model 820, a training module 830, a validation module 840, an inference module 850, and a datastore 860. In other embodiments, alternative configurations, different or additional components may be included in the DNN system 800. Further, functionality attributed to a component of the DNN system 800 may be accomplished by a different component included in the DNN system 800 or a different system. The DNN system 800 or a component of the DNN system 800 (e.g., the training module 830 or inference module 850) may include the computing device 900 in FIG. 9.

The interface module 810 facilitates communication of the DNN system 800 with other systems. As an example, the interface module 810 supports the DNN system 800 to distribute trained DNNs to other systems, e.g., computing devices configured to apply DNNs to perform tasks. As another example, the interface module 810 establishes communication between the DNN system 800 and an external database to receive data that can be used to train DNNs or input into DNNs to perform tasks. In some embodiments, data received by the interface module 810 may have a data structure, such as a matrix. In some embodiments, data received by the interface module 810 may be an image, a series of images, and/or a video stream.

The harmonization model 820 predicts parameters for harmonizing images. In some examples, the harmonization model 820 performs harmonization parameter prediction on low-resolution images. In general, the harmonization model 820 includes an encoder and a decoder. The harmonization model 820 receives downscaled image data (i.e., a low-resolution version of the current image frame and a low-resolution version of the background image frame), and generates predicted harmonization parameter predictions including a predicted harmonization parameter for pixels of the foreground portion of the downscaled current image. During training, the harmonization model 820 can use ground-truth harmonized images.

The training module 830 trains DNNs by using training datasets. In some embodiments, a training dataset for training a DNN may include one or more images and/or videos, each of which may be a training sample. In some examples, the training module 830 trains the harmonization model 820. The training module 830 may receive real-world image data for processing with the harmonization model 820 as described herein. In some embodiments, the training module 830 may input different data into different layers of the DNN. For every subsequent DNN layer, the input data may be less than the previous DNN layer. In some examples, the harmonization model 820 can be trained with ground-truth harmonized images as discussed with respect to FIG. 6. In some examples, the difference between the harmonization model 820 harmonized image output and the corresponding ground-truth harmonized image can be measured as the number of pixels in the corresponding maps that have different classifications from each other.

In some embodiments, a part of the training dataset may be used to initially train the DNN, and the rest of the training dataset may be held back as a validation subset used by the validation module 840 to validate the performance of a trained DNN. The portion of the training dataset not including the tuning subset and the validation subset may be used to train the DNN.

The training module 830 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as the number of hidden layers, etc. Hyperparameters also include variables that determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backward through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 830 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of the input image after convolution. It is used between two convolutional layers. A fully connected layer involves weights, biases, and neurons. It connects neurons in one layer to neurons in another layer. It is used to classify images between different categories by training.

In the process of defining the architecture of the DNN, the training module 830 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 830 defines the architecture of the DNN, the training module 830 inputs a training dataset into the DNN. The training dataset includes a plurality of training samples. An example of a training dataset includes a series of images of a video stream. Unlabeled, real-world video is input to the harmonization model, and processed using the harmonization model parameters of the DNN to produce two different model-generated outputs: a first time-forward model-generated output and a second time-reversed model-generated output. In the backward pass, the training module 830 modifies the parameters inside the DNN (“internal parameters of the DNN”) to minimize the differences between the first model-generated output and the second model-generated output. The internal parameters include weights of filters in the convolutional layers of the DNN. In some embodiments, the training module 830 uses a cost function to minimize the differences.

The training module 830 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 830 finishes the predetermined number of epochs, the training module 830 may stop updating the parameters in the DNN. The DNN having the updated parameters is referred to as a trained DNN.

The validation module 840 verifies the accuracy of trained DNNs. In some embodiments, the validation module 840 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 840 may determine an accuracy score measuring the precision, recall, or a combination of precision and recall of the DNN. The validation module 840 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 840 may compare the accuracy score with a threshold score. In an example where the validation module 840 determines that the accuracy score of the augmented model is lower than the threshold score, the validation module 840 instructs the training module 830 to re-train the DNN. In one embodiment, the training module 830 may iteratively re-train the DNN until the occurrence of a stopping condition, such as the accuracy measurement indicating that the DNN may be sufficiently accurate, or a number of training rounds having taken place.

The inference module 850 applies the trained or validated DNN to perform tasks. The inference module 850 may run inference processes of a trained or validated DNN. In some examples, inference makes use of the forward pass to produce model-generated output for unlabeled real-world data. For instance, the inference module 850 may input real-world data into the DNN and receive an output of the DNN. The output of the DNN may provide a solution to the task for which the DNN is trained.

The inference module 850 may aggregate the outputs of the DNN to generate a final result of the inference process. In some embodiments, the inference module 850 may distribute the DNN to other systems, e.g., computing devices in communication with the DNN system 800, for the other systems to apply the DNN to perform the tasks. The distribution of the DNN may be done through the interface module 810. In some embodiments, the DNN system 800 may be implemented in a server, such as a cloud server, an edge service, and so on. The computing devices may be connected to the DNN system 800 through a network. Examples of the computing devices include edge devices.

The datastore 860 stores data received, generated, used, or otherwise associated with the DNN system 800. For example, the datastore 860 stores video processed by the harmonization model 820 or used by the training module 830, validation module 840, and the inference module 850. The datastore 860 may also store other data generated by the training module 830 and validation module 840, such as the hyperparameters for training DNNs, internal parameters of trained DNNs (e.g., values of tunable parameters of activation functions, such as Fractional Adaptive Linear Units (FALUs)), etc. In the embodiment of FIG. 8, the datastore 860 is a component of the DNN system 800. In other embodiments, the datastore 860 may be external to the DNN system 800 and communicate with the DNN system 800 through a network.

In general, an uncalibrated or badly calibrated harmonization model would fail to harmonize the foreground of the input image with visual characteristics of the background image.

For harmonization model training, the input can include an input image frame and a labeled ground-truth harmonization model-processed image. In various examples, the input image frame is received at an image processing system, such as the adaptive real-time ISP harmonization systems 100, 200, and/or the harmonization model 820. In other examples, the input image frame can be received at the training module 830 or the inference module 850 of FIG. 8. The imager can be a camera, such as a video camera. The input image frame can be a still image from the video camera feed. The input image frame can include a matrix of pixels, each pixel having a color, lightness, and/or other parameter. The input image frame can be downscaled and processed by a pre-processing block. Various steps can be repeated to further adjust the harmonization model parameters. In some examples, the training can be repeated with a new input image frame and ground-truth harmonization model-processed image.

### Example Computing Device

FIG. 9 is a block diagram of an example computing device 900, in accordance with various embodiments. In some embodiments, the computing device 900 may be used for at least part of the deep learning system 800 in FIG. 8. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or a video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 904 may include memory that shares a die with the processing device 902. In some embodiments, the memory 904 includes one or more non-transitory computer-readable media storing instructions executable for image harmonization, e.g., the method 700 described above in conjunction with FIG. 7 or some operations performed by the DNN system 800 in FIG. 8. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Selected Examples

The following paragraphs provide various examples of the embodiments disclosed herein.

Example 1 provides an apparatus, including a computer processor for executing computer program instructions; and a non-transitory computer-readable memory storing computer program instructions executable by the computer processor to perform operations including receiving, at an image signal processor (ISP), a raw sensor image including a foreground region and a background region; receiving a background image having visual characteristics different from the foreground region; downscaling the raw sensor image and the background image to generate a low-resolution sensor image and a low-resolution background image; applying a harmonization neural network to the low-resolution sensor image and the low-resolution background image to predict at least one ISP hardware block parameter; configuring at least one ISP hardware block based on the predicted at least one ISP hardware block parameter; processing the raw sensor image through the ISP to generate a processed image in which the foreground region matches the visual characteristics of the background image; and generating a harmonized output image by blending the foreground region of the processed image with the background image.

Example 2 provides the apparatus of example 1, where the operations further include generating a foreground segmentation mask identifying the foreground region within the raw sensor image, and where applying the harmonization neural network includes applying the harmonization neural network to the low-resolution sensor image, the low-resolution background image, and the foreground segmentation mask to predict the at least one ISP hardware block parameter.

Example 3 provides the apparatus of example 2, where generating the foreground segmentation mask includes applying a segmentation AI model to the low-resolution sensor image.

Example 4 provides the apparatus of any of examples 1-3, where the at least one ISP hardware block includes at least one of a white balance (WB) block, a color correction matrix (CCM) block, a tone mapping (TM) block, and a color space conversion (CSC) block.

Example 5 provides the apparatus of example 4, where configuring the at least one ISP hardware block includes configuring the WB block, the CCM block, and the TM block to perform color reproduction harmonization of the foreground region.

Example 6 provides the apparatus of example 4 and/or example 5, where configuring the at least one ISP hardware block includes configuring the TM block and the CSC block to perform post color reproduction harmonization of the foreground region.

Example 7 provides the apparatus of example 6, where configuring the CSC block includes replacing a standard color space conversion matrix with a combined matrix that performs a color mapping operation and a color space conversion from RGB to YUV in a single matrix operation.

Example 8 provides the apparatus of example 7, where the combined matrix is determined based on the at least one ISP hardware block parameter predicted by the harmonization neural network.

Example 9 provides the apparatus of any of examples 4-8, where configuring the TM block includes determining a total harmonized tone mapping response by combining an original tone mapping response derived from ISP scene statistics with a multiplicative correction curve predicted by the harmonization neural network.

Example 10 provides the apparatus of example 9, where configuring the TM block includes applying the total harmonized tone mapping response to the TM block as a lookup table.

Example 11 provides the apparatus of any of examples 1-10, where the operations further include blending the predicted at least one ISP hardware block parameter with an original ISP hardware block parameter according to a blending factor ranging from zero to one.

Example 12 provides the apparatus of example 11, where a blending factor of one yields no harmonization and a blending factor of zero yields full application of the predicted at least one ISP hardware block parameter.

Example 13 provides the apparatus of example 11 and/or 12, where the blending factor is set manually by a user.

Example 14 provides the apparatus of any of examples 11-13, where the blending factor is determined automatically based on skin tone statistics of a detected face in the foreground region, such that hue, saturation, and brightness of harmonized skin tones remain within a natural range, thereby preventing over-harmonization or under-harmonization of the foreground region.

Example 15 provides the apparatus of example 14, where determining the blending factor automatically includes applying face detection to the low-resolution sensor image to identify a face region within the foreground region, aggregating skin tone statistics from the identified face region, and constraining the blending factor to a value at which predicted skin tone hue, saturation, and brightness values resulting from application of the blended parameter remain within a predefined natural skin tone range.

Example 16 provides the apparatus of any of examples 1-15, where downscaling the raw sensor image includes applying pixel binning at a downscale ratio of 1/8, and where the harmonization neural network operates on the downscaled low-resolution sensor image and the downscaled low-resolution background image.

Example 17 provides the apparatus of any of examples 1-16, where the raw sensor image is processed through the ISP at a bit depth of at least 10 bits, such that the predicted at least one ISP hardware block parameter is applied to the foreground region before bit-depth reduction.

Example 18 provides the apparatus of any of examples 1-17, where applying the harmonization neural network includes extracting a first feature embedding from the low-resolution sensor image and a second feature embedding from the low-resolution background image using independent feature extraction branches, where the second feature embedding is computed once and cached for reuse across multiple frames of the video stream.

Example 19 provides the apparatus of example 18, where each feature extraction branch includes a plurality of convolutional blocks, a bottleneck block, and a global average pooling block, and where the harmonization neural network further includes a multilayer perceptron (MLP) that receives a concatenation of the first feature embedding, the second feature embedding, and foreground segmentation mask statistics, and outputs the predicted at least one ISP hardware block parameter.

Example 20 provides the apparatus of example 18 and/or 19, where the harmonization neural network applies semantically differentiated harmonization parameters to different foreground objects having similar initial colors based on the semantic class of each object, such that skin tone regions of a person are harmonized differently from non-person foreground objects.

Example 21 provides the apparatus of any of examples 1-20, where the operations further include reducing an inference rate of the harmonization neural network below a frame rate of the video stream when no significant scene change is detected, and triggering an asynchronous reset and immediate re-inference of the harmonization neural network upon detection of a significant scene change based on ISP statistics.

Example 22 provides the apparatus of example 21, where the operations further include applying an infinite impulse response (IIR) filter to successive predicted ISP hardware block parameters to generate a smoothed parameter estimate at every frame of the video stream.

Example 23 provides the apparatus of any of examples 1-22, where generating the harmonized output image includes, for each pixel of the harmonized output image, selecting a pixel value from the processed image where the foreground segmentation mask identifies the pixel as belonging to the foreground region, and selecting a pixel value from the background image where the foreground segmentation mask identifies the pixel as belonging to the background region.

Example 24 provides the apparatus of any of examples 1-23, where the foreground region includes at least one of a person segmented from a live camera scene for background replacement in a video call, or newly inserted content to be harmonized with respect to an original scene background.

Example 25 provides one or more non-transitory computer-readable media storing instructions executable to perform operations, the operations including receiving, at an image signal processor (ISP), a raw sensor image including a foreground region and a background region; receiving a background image having visual characteristics different from the foreground region; downscaling the raw sensor image and the background image to generate a low-resolution sensor image and a low-resolution background image; applying a harmonization neural network to the low-resolution sensor image and the low-resolution background image to predict at least one ISP hardware block parameter; configuring at least one ISP hardware block based on the predicted at least one ISP hardware block parameter; processing the raw sensor image through the ISP to generate a processed image in which the foreground region matches the visual characteristics of the background image; and generating a harmonized output image by blending the foreground region of the processed image with the background image.

Example 26 provides the non-transitory computer-readable media of example 25, where the operations further include generating a foreground segmentation mask identifying the foreground region within the raw sensor image, and where applying the harmonization neural network includes applying the harmonization neural network to the low-resolution sensor image, the low-resolution background image, and the foreground segmentation mask to predict the at least one ISP hardware block parameter.

Example 27 provides the non-transitory computer-readable media of example 26, where generating the foreground segmentation mask includes applying a segmentation AI model to the low-resolution sensor image.

Example 28 provides the non-transitory computer-readable media of any of examples 25-27, where the at least one ISP hardware block includes at least one of a white balance (WB) block, a color correction matrix (CCM) block, a tone mapping (TM) block, and a color space conversion (CSC) block.

Example 29 provides the non-transitory computer-readable media of example 28, where configuring the at least one ISP hardware block includes configuring the WB block, the CCM block, and the TM block to perform color reproduction harmonization of the foreground region.

Example 30 provides the non-transitory computer-readable media of example 28 and/or example 29, where configuring the at least one ISP hardware block includes configuring the TM block and the CSC block to perform post-color-reproduction harmonization of the foreground region.

Example 31 provides the non-transitory computer-readable media of example 30, where configuring the CSC block includes replacing a standard color space conversion matrix with a combined matrix that performs a color mapping operation and a color space conversion from RGB to YUV in a single matrix operation.

Example 32 provides the non-transitory computer-readable media of example 31, where the combined matrix is determined based on the at least one ISP hardware block parameter predicted by the harmonization neural network.

Example 33 provides the non-transitory computer-readable media of any of examples 28-32, where configuring the TM block includes determining a total harmonized tone mapping response by combining an original tone mapping response derived from ISP scene statistics with a multiplicative correction curve predicted by the harmonization neural network.

Example 34 provides the non-transitory computer-readable media of example 33, where configuring the TM block includes applying the total harmonized tone mapping response to the TM block as a lookup table.

Example 35 provides the non-transitory computer-readable media of any of examples 25-34, where the operations further include blending the predicted at least one ISP hardware block parameter with an original ISP hardware block parameter according to a blending factor ranging from zero to one.

Example 36 provides the non-transitory computer-readable media of example 35, where a blending factor of one yields no harmonization and a blending factor of zero yields full application of the predicted at least one ISP hardware block parameter.

Example 37 provides the non-transitory computer-readable media of example 35 or example 36, where the blending factor is set manually by a user.

Example 38 provides the non-transitory computer-readable media of any of examples 35-37, where the blending factor is determined automatically based on skin tone statistics of a detected face in the foreground region, such that hue, saturation, and brightness of harmonized skin tones remain within a natural range, thereby preventing over-harmonization or under-harmonization of the foreground region.

Example 39 provides the non-transitory computer-readable media of example 38, where determining the blending factor automatically includes applying face detection to the low-resolution sensor image to identify a face region within the foreground region, aggregating skin tone statistics from the identified face region, and constraining the blending factor to a value at which predicted skin tone hue, saturation, and brightness values resulting from application of the blended parameter remain within a predefined natural skin tone range.

Example 40 provides the non-transitory computer-readable media of any of examples 25-39, where downscaling the raw sensor image includes applying pixel binning at a downscale ratio of 1/8, and where the harmonization neural network operates on the downscaled low-resolution sensor image and the downscaled low-resolution background image.

Example 41 provides the non-transitory computer-readable media of any of examples 25-40, where the raw sensor image is processed through the ISP at a bit depth of at least 10 bits, such that the predicted at least one ISP hardware block parameter is applied to the foreground region before bit-depth reduction.

Example 42 provides the non-transitory computer-readable media of any of examples 25-41, where applying the harmonization neural network includes extracting a first feature embedding from the low-resolution sensor image and a second feature embedding from the low-resolution background image using independent feature extraction branches, where the second feature embedding is computed once and cached for reuse across multiple frames of a video stream.

Example 43 provides the non-transitory computer-readable media of example 42, where each feature extraction branch includes a plurality of convolutional blocks, a bottleneck block, and a global average pooling block, and where the harmonization neural network further includes a multilayer perceptron (MLP) that receives a concatenation of the first feature embedding, the second feature embedding, and foreground segmentation mask statistics, and outputs the predicted at least one ISP hardware block parameter.

Example 44 provides the non-transitory computer-readable media of example 42 and/or 43, where the harmonization neural network applies semantically differentiated harmonization parameters to different foreground objects having similar initial colors based on a semantic class of each object, such that skin-tone regions of a person are harmonized differently from non-person foreground objects.

Example 45 provides the non-transitory computer-readable media of any of examples 25-44, where the operations further include reducing an inference rate of the harmonization neural network below a frame rate of a video stream when no significant scene change is detected, and triggering an asynchronous reset and immediate re-inference of the harmonization neural network upon detection of a significant scene change based on ISP statistics.

Example 46 provides the non-transitory computer-readable media of example 45, where the operations further include applying an infinite impulse response (IIR) filter to successive predicted ISP hardware block parameters to generate a smoothed parameter estimate at every frame of the video stream.

Example 47 provides the non-transitory computer-readable media of any one of examples 25-46, where generating the harmonized output image includes, for each pixel of the harmonized output image, selecting a pixel value from the processed image where the foreground segmentation mask identifies the pixel as belonging to the foreground region, and selecting a pixel value from the background image where the foreground segmentation mask identifies the pixel as belonging to the background region.

Example 48 provides the non-transitory computer-readable media of any of examples 25-47, where the foreground region includes at least one of a person segmented from a live camera scene for background replacement in a video call, or newly inserted content to be harmonized with respect to an original scene background.

Example 49 provides a computer-implemented method, including receiving, at an image signal processor (ISP), a raw sensor image including a foreground region and a background region; receiving a background image having visual characteristics different from the foreground region; downscaling the raw sensor image and the background image to generate a low-resolution sensor image and a low-resolution background image; applying a harmonization neural network to the low-resolution sensor image and the low-resolution background image to predict at least one ISP hardware block parameter; configuring at least one ISP hardware block based on the predicted at least one ISP hardware block parameter; processing the raw sensor image through the ISP to generate a processed image in which the foreground region matches the visual characteristics of the background image; and generating a harmonized output image by blending the foreground region of the processed image with the background image.

Example 50 provides the method of example 49, further including generating a foreground segmentation mask identifying the foreground region within the raw sensor image, where applying the harmonization neural network includes applying the harmonization neural network to the low-resolution sensor image, the low-resolution background image, and the foreground segmentation mask to predict the at least one ISP hardware block parameter.

Example 51 provides the method of example 50, where generating the foreground segmentation mask includes applying a segmentation AI model to the low-resolution sensor image.

Example 52 provides the method of any of examples 49-51, where the at least one ISP hardware block includes at least one of a white balance (WB) block, a color correction matrix (CCM) block, a tone mapping (TM) block, and a color space conversion (CSC) block.

Example 53 provides the method of example 52, where configuring the at least one ISP hardware block includes configuring the WB block, the CCM block, and the TM block to perform color reproduction harmonization of the foreground region.

Example 54 provides the method of example 52 or 53, where configuring the at least one ISP hardware block includes configuring the TM block and the CSC block to perform post-color-reproduction harmonization of the foreground region.

Example 55 provides the method of example 54, where configuring the CSC block includes replacing a standard color space conversion matrix with a combined matrix that performs a color mapping operation and a color space conversion from RGB to YUV in a single matrix operation.

Example 56 provides the method of example 55, where the combined matrix is determined based on the at least one ISP hardware block parameter predicted by the harmonization neural network.

Example 57 provides the method of any of examples 52-56, where configuring the TM block includes determining a total harmonized tone mapping response by combining an original tone mapping response derived from ISP scene statistics with a multiplicative correction curve predicted by the harmonization neural network.

Example 58 provides the method of example 57, where configuring the TM block includes applying the total harmonized tone mapping response to the TM block as a lookup table.

Example 59 provides the method of any one of examples 49-58, further including blending the predicted at least one ISP hardware block parameter with an original ISP hardware block parameter according to a blending factor ranging from zero to one.

Example 60 provides the method of example 59, where a blending factor of one yields no harmonization and a blending factor of zero yields full application of the predicted at least one ISP hardware block parameter.

Example 61 provides the method of example 59 and/or 60, where the blending factor is set manually by a user.

Example 62 provides the method of any of examples 59-61, where the blending factor is determined automatically based on skin tone statistics of a detected face in the foreground region, such that hue, saturation, and brightness of harmonized skin tones remain within a natural range, thereby preventing over-harmonization or under-harmonization of the foreground region.

Example 63 provides the method of example 62, where determining the blending factor automatically includes applying face detection to the low-resolution sensor image to identify a face region within the foreground region, aggregating skin tone statistics from the identified face region, and constraining the blending factor to a value at which predicted skin tone hue, saturation, and brightness values resulting from application of the blended parameter remain within a predefined natural skin tone range.

Example 64 provides the method of any of examples 49-63, where downscaling the raw sensor image includes applying pixel binning at a downscale ratio of 1/8, and where the harmonization neural network operates on the downscaled low-resolution sensor image and the downscaled low-resolution background image.

Example 65 provides the method of any of examples 49-64, where the raw sensor image is processed through the ISP at a bit depth of at least 10 bits, such that the predicted at least one ISP hardware block parameter is applied to the foreground region before bit-depth reduction.

Example 66 provides the method of any of examples 49-65, where applying the harmonization neural network includes extracting a first feature embedding from the low-resolution sensor image and a second feature embedding from the low-resolution background image using independent feature extraction branches, where the second feature embedding is computed once and cached for reuse across multiple frames of a video stream.

Example 67 provides the method of example 66, where each feature extraction branch includes a plurality of convolutional blocks, a bottleneck block, and a global average pooling block, and where the harmonization neural network further includes a multilayer perceptron (MLP) that receives a concatenation of the first feature embedding, the second feature embedding, and foreground segmentation mask statistics, and outputs the predicted at least one ISP hardware block parameter.

Example 68 provides the method of example 66 and/or 67, where the harmonization neural network applies semantically differentiated harmonization parameters to different foreground objects having similar initial colors based on a semantic class of each object, such that skin-tone regions of a person are harmonized differently from non-person foreground objects.

Example 69 provides the method of any of examples 49-68, further including reducing an inference rate of the harmonization neural network below a frame rate of a video stream when no significant scene change is detected, and triggering an asynchronous reset and immediate re-inference of the harmonization neural network upon detection of a significant scene change based on ISP statistics.

Example 70 provides the method of example 69, further including applying an infinite impulse response (IIR) filter to successive predicted ISP hardware block parameters to generate a smoothed parameter estimate at every frame of the video stream.

Example 71 provides the method of any of examples 49-70, where generating the harmonized output image includes, for each pixel of the harmonized output image, selecting a pixel value from the processed image where the foreground segmentation mask identifies the pixel as belonging to the foreground region, and selecting a pixel value from the background image where the foreground segmentation mask identifies the pixel as belonging to the background region.

Example 72 provides the method of any of examples 49-71, where the foreground region includes at least one of a person segmented from a live camera scene for background replacement in a video call, or newly inserted content to be harmonized with respect to an original scene background.

Example 73 provides the apparatus of example 23, where the foreground segmentation mask is a soft mask, and where each pixel of the harmonized output image is determined as a weighted blend of a corresponding pixel value from the processed image and a corresponding pixel value from the background image according to a respective soft mask pixel value at a corresponding pixel location.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
a computer processor for executing computer program instructions; and
a non-transitory computer-readable memory storing computer program instructions executable by the computer processor to perform operations comprising:
receiving, at an image signal processor (ISP), a raw sensor image comprising a foreground region and a background region;
receiving a background image having visual characteristics different from the foreground region;
downscaling the raw sensor image and the background image to generate a low-resolution sensor image and a low-resolution background image;
applying a harmonization neural network to the low-resolution sensor image and the low-resolution background image to predict at least one ISP hardware block parameter;
configuring at least one ISP hardware block based on the predicted at least one ISP hardware block parameter;
processing the raw sensor image through the ISP to generate a processed image in which the foreground region matches the visual characteristics of the background image; and
generating a harmonized output image by blending the foreground region of the processed image with the background image.

2. The apparatus of claim 1, wherein the operations further comprise generating a foreground segmentation mask identifying the foreground region within the raw sensor image, and wherein applying the harmonization neural network comprises applying the harmonization neural network to the low-resolution sensor image, the low-resolution background image, and the foreground segmentation mask to predict the at least one ISP hardware block parameter.

3. The apparatus of claim 1, wherein the at least one ISP hardware block comprises at least one of a white balance (WB) block, a color correction matrix (CCM) block, a tone mapping (TM) block, and a color space conversion (CSC) block.

4. The apparatus of claim 3, wherein configuring the at least one ISP hardware block comprises configuring the WB block, the CCM block, and the TM block to perform color reproduction harmonization of the foreground region.

5. The apparatus of claim 3, wherein configuring the at least one ISP hardware block includes configuring the TM block and the CSC block to perform post-color reproduction harmonization of the foreground region.

6. The apparatus of claim 5, wherein configuring the CSC block includes replacing a standard color space conversion matrix with a combined matrix that performs a color mapping operation and a color space conversion from RGB to YUV in a single matrix operation.

7. The apparatus of claim 3, wherein configuring the TM block includes determining a total harmonized tone mapping response by combining an original tone mapping response derived from ISP scene statistics with a multiplicative correction curve predicted by the harmonization neural network.

8. The apparatus of claim 1, wherein the operations further comprise blending the predicted at least one ISP hardware block parameter with an original ISP hardware block parameter according to a blending factor ranging from zero to one.

9. The apparatus of claim 8, wherein a blending factor of one yields no harmonization and a blending factor of zero yields full application of the predicted at least one ISP hardware block parameter.

10. The apparatus of claim 1, wherein generating the harmonized output image comprises, for each pixel of the harmonized output image, selecting a pixel value from the processed image where a foreground segmentation mask identifies the pixel as belonging to the foreground region, and selecting a pixel value from the background image where the foreground segmentation mask identifies the pixel as belonging to the background region.

11. The apparatus of claim 1, wherein the foreground region comprises at least one of a person segmented from a live camera scene for background replacement in a video call, or newly inserted content to be harmonized with respect to an original scene background.

12. One or more non-transitory computer-readable media storing instructions executable to perform operations, the operations comprising:
receiving, at an image signal processor (ISP), a raw sensor image comprising a foreground region and a background region;
receiving a background image having visual characteristics different from the foreground region;
downscaling the raw sensor image and the background image to generate a low-resolution sensor image and a low-resolution background image;
applying a harmonization neural network to the low-resolution sensor image and the low-resolution background image to predict at least one ISP hardware block parameter;
configuring at least one ISP hardware block based on the predicted at least one ISP hardware block parameter;
processing the raw sensor image through the ISP to generate a processed image in which the foreground region matches the visual characteristics of the background image; and
generating a harmonized output image by blending the foreground region of the processed image with the background image.

13. The one or more non-transitory computer-readable media of claim 12, wherein the operations further comprise generating a foreground segmentation mask identifying the foreground region within the raw sensor image, and wherein applying the harmonization neural network comprises applying the harmonization neural network to the low-resolution sensor image, the low-resolution background image, and the foreground segmentation mask to predict the at least one ISP hardware block parameter.

14. The one or more non-transitory computer-readable media of claim 12, wherein the at least one ISP hardware block comprises at least one of a white balance (WB) block, a color correction matrix (CCM) block, a tone mapping (TM) block, and a color space conversion (CSC) block.

15. The one or more non-transitory computer-readable media of claim 14, wherein configuring the at least one ISP hardware block comprises configuring the WB block, the CCM block, and the TM block to perform color reproduction harmonization of the foreground region.

16. The one or more non-transitory computer-readable media of claim 14, wherein configuring the at least one ISP hardware block includes configuring the TM block and the CSC block to perform post-color-reproduction harmonization of the foreground region.

17. The one or more non-transitory computer-readable media of claim 16, wherein configuring the CSC block includes replacing a standard color space conversion matrix with a combined matrix that performs a color mapping operation and a color space conversion from RGB to YUV in a single matrix operation.

18. The one or more non-transitory computer-readable media of claim 14, wherein configuring the TM block includes determining a total harmonized tone mapping response by combining an original tone mapping response derived from ISP scene statistics with a multiplicative correction curve predicted by the harmonization neural network.

19. The one or more non-transitory computer-readable media of claim 12, wherein generating the harmonized output image comprises, for each pixel of the harmonized output image, selecting a pixel value from the processed image where a foreground segmentation mask identifies the pixel as belonging to the foreground region, and selecting a pixel value from the background image where the foreground segmentation mask identifies the pixel as belonging to the background region.

20. A computer-implemented method, comprising:
receiving, at an image signal processor (ISP), a raw sensor image comprising a foreground region and a background region;
receiving a background image having visual characteristics different from the foreground region;
downscaling the raw sensor image and the background image to generate a low-resolution sensor image and a low-resolution background image;
applying a harmonization neural network to the low-resolution sensor image and the low-resolution background image to predict at least one ISP hardware block parameter;
configuring at least one ISP hardware block based on the predicted at least one ISP hardware block parameter;
processing the raw sensor image through the ISP to generate a processed image in which the foreground region matches the visual characteristics of the background image; and
generating a harmonized output image by blending the foreground region of the processed image with the background image.
